(19) United States
(12) Patent Application Publication
(10) Pub. No.: US 2026/0357156 A1
(43) Pub. Date: Nov. 12, 2026

(54) POLYMERS, AQUEOUS COMPOSITIONS COMPRISING SUCH POLYMERS, AND USE AS LAUNDRY DETERGENTS

(71) Applicant: BASF SE, Ludwigshafen am Rhein (DE)

(72) Inventors: Helen ROTHER-NOEDING, Ludwigshafen (DE); Harald KELLER, Ludwigshafen (DE); Thomas WEISS, Ludwigshafen (DE); Martin ERNST, Ludwigshafen (DE); Jochen Eckhard WILLERSINN, Ludwigshafen (DE); Stephan HUEFFER, Ludwigshafen (DE); Catharina WOHLMUTH, Ludwigshafen (DE); Helmut WITTELER, Ludwigshafen (DE)

(21) Appl. No.: 19/483,048

(22) PCT Filed: May 13, 2024
(86) PCT No.: PCT/EP2024/063040

§ 371 Date: Nov. 10, 2025

(30) Foreign Application Priority Data
May 23, 2023 (EP) 23174900.3

(51) Int. Cl. C11D 3/37; C11D 3/22; C11D 3/386

(52) U.S. Cl. CPC C11D 3/3719; C11D 3/227; C11D 3/38636

(57) ABSTRACT

Disclosed herein is an aqueous composition including
at least one polymer including
   (a) a core formed by an aliphatic di-, tri- or tetracarboxylic acid amidated with aliphatic triamine or tetraamine where the amino groups are connected through C₂-C₄-alkylene groups where at least 50 mol-% of the C₂-C₄-alkylene groups are alkylene groups with at least three carbon atoms, and
(b) wherein at least 30 mol-% of the primary amino groups of core (a) are linked through an amide group or through a secondary amino group of the general formula —(CH₂)ₙ—NH—CH₂— to at least one mono-, di- or polysaccharide, the variable a being selected from 2 to 4.

The present invention relates to aqueous composition comprising
(A) at least one polymer comprising
   (a) a core formed by an aliphatic di-, tri- or tetracarboxylic acid amidated with aliphatic triamines or tetraamines wherein the amino groups are connected through C₂-C₄-alkylene groups wherein at least 50 mol-% of the C₂-C₄-alkylene groups are alkylene groups with at least three carbon atoms,
   (b) wherein at least 30 mol-% of the primary amino groups of core (a) are linked through an amide group or through a secondary amino group of the general formula —(CH₂)ₙ—NH—CH₂— to at least one mono-, di- or polysaccharide, the variable a being selected from 2 to 4.

Furthermore, the present invention is directed to polymers (A) useful for such compositions, and to a process for making such polymers (A), and furthermore their manufacture, their uses, particularly for use in cleaning compositions such as laundry detergent compositions, and specifically for improved clay removal in laundry care.

Detergent formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, by-products of incomplete hydrocarbon combustion, and organic soils like sebum.

Clay stains are still a challenge in laundering. Said challenge may be associated with the high degree of surface charge density associated with the clay itself. This high surface charge density may act to repel some laundry ingredients. Thus, surfactants alone cannot remove or carry away the clay into the laundry liquor. Furthermore, to date no enzyme technology is available to achieve satisfactory cleaning benefits on this type of soil. Although numerous suggestions for clay removal have been made-polymers, enzymes, surfactants-solutions that work well are still of interest.

Furthermore, there is a continuous need in laundering to keep the removed soil in suspension during the washing process, since initially removed soil can redeposit on the surface of the fabric during wash and thus cause so-called “greying”. This greying effect is especially noticeable on white textiles but might also affect the appearance of colored textiles.

The term “textile” means any textile material including yarns (thread made of natural or synthetic fibers used for knitting or weaving), yarn intermediates, fibers, non-woven materials, natural materials, synthetic materials, as well as fabrics (a textile made by waving, knitting or felting fibers) made of these materials such as garments (any article of clothing made from textile), cloths and other articles.

The term “redeposition” herein means deposition of dirt or color components that were removed from textiles during laundering. The term “anti-redeposition” in this respect means the action to prevent or diminish the redeposition of dirt and colored components on the textile.

The term “anti-greying” herein means the reduction and/or removal of “greying” from laundry.

Furthermore, one of the most important targets of the detergent and cleaner (D&C) industry today is the need for biodegradability, thus, to improve the sustainability of the detergent formulations and to avoid the potential accumulation of ingredients or their degradation products resulting from incomplete biodegradation of the polymers in the ecosystem. It is thus required to lower the persistence in nature after usage of the laundry detergents and of their ingredients. Hence, there is a strong need for new biodegradable cleaning polymers that provide both excellent primary (i.e., soil removal) and secondary (i.e., whiteness maintenance) cleaning benefits and an improved biodegradability.

Ideally, the polymers are readily biodegradable, i.e., show equal to or more than 60% oxygen consumption after 28 days in the OECD 301 F test or at least show equal to or more than 60% after 56 days in the OECD 301 F test. Alternatively, polymers are inherently biodegradable in the OECD 302B test, i.e., show equal to or more than 70% dissolved organic carbon (DOC) levels. Hence, there was a need to find polymer architectures with a superior performance profile, a feasible preparation process and an improved biodegradation behavior.

Accordingly, the aqueous compositions defined at the outset have been found, hereinafter also referred to as inventive (aqueous) compositions or compositions according to the present invention. Inventive compositions contain at least one polymer (A) that comprises several building blocks:
(a) a core formed by an aliphatic di-, tri- or tetracarboxylic acid amidated with aliphatic triamines or tetraamines wherein the amino groups are connected through C₂-C₄-alkylene groups wherein at least 50 mol-% of the C₂-C₄-alkylene groups are alkylene groups with at least three carbon atoms,
(b) wherein at least 30 mol-% of the amino groups are linked through an amide group or a secondary amino group of the general formula —(CH₂)ₙ—NH—CH₂— to at least one mono-, di- or polysaccharide, the variable a being selected from 2 to 4.

The term “aqueous compositions” refers to compositions that are liquid at ambient temperatures and whose main solvent is water. Preferably, less than 10% by vol of the solvent is a solvent other than water, for example 1,2-propylene glycol, ethylene glycol, or diethylene glycol.

Preferably, inventive compositions are laundry compositions or detergent compositions.

Inventive aqueous compositions contain at least one polymer (A) that shall be described in more detail below. Polymer (A) contains a core (a), in the context of the present invention also referred to as (a), and poly alkylene oxide chains (b), also referred to as (b).

In one embodiment of the present invention, inventive compositions contain in the range of from 0.1 to 10% by weight of polymer (A), referring to the solids content of the respective aqueous composition, preferred are 1.0 to 5.0% by weight. The solids content may be determined by evaporation of all volatiles at a temperature of 100 °C in vacuo until the weight remains constant for at least 30 minutes.

Core (a) is formed by an aliphatic di-, tri- or tetracarboxylic acid, preferably a di- or tricarboxylic acid. Said aliphatic di-, tri- or tetracarboxylic acid may bear 3 to 8 carbon atoms, whereas tetracarboxylic acids need to have at least 6 carbon atoms, preferred are di- and tricarboxylic acids with 4 to 6 carbon atoms. Said aliphatic di-, tri- or tetracarboxylic acid may bear the carboxylic acid groups as sole functional groups, or it may bear functional groups other than carboxylic acid groups, especially secondary or tertiary hydroxyl groups. Examples are adipic acid, glutamic acid, tartaric acid, malic acid, propane-1,2,3-tricarboxylic acid, citric acid, sebacic acid, succinic acid, butane 1,2,3,4-tetracarboxylic acid, and malonic acid, preferred examples are adipic acid, glutamic acid, tartaric acid, malic acid and citric acid.

Said aliphatic di-, tri- or tetracarboxylic acid is amidated with aliphatic triamine or tetraamine wherein the amino groups are connected through C₂-C₄-alkylene groups wherein at least 50 mol-% of the C₂-C₄-alkylene groups are alkylene groups with at least three carbon atoms. Although it is possible to achieve a complete amidation with no free carboxylic acid groups remaining it may occur that up to 20 mol-%, preferably only up to 10 or even to 5 mol-% of the carboxylic acid groups remain unreacted. Amidation may occur in each case by a secondary and preferably by a primary amino group.

Examples of suitable triamines are N3-amine (2-aminoethyl-1,3-propanediamine), 2-aminoethyl-1,4-butanediamine, 2-aminopropyl-1,4-butanediamine, diethylene triamine (“DETA”) and combinations of at least two of the foregoing. Examples of suitable tetramines are N4-amine (N,N′-bis(3-aminopropyl)-1,2-ethylenediamine), 1,2-(w-aminobutyl)-1,2-ethylendiamine, H₂N—(CH₂)₃—NH—(CH₂)₄—NH—(CH₂)₃—NH₂, triethylene tetraamine (“TETA”), and preferred aliphatic triamines or tetraamines are selected from N,N′-bis(3-aminopropyl)-1,3-propanediamine, N4-amine, N3-amine and combinations of N3-amine and N4-amine, and combinations of at least two of the foregoing.

The above amine(s) may be combined with a diamine, especially an aliphatic diamine, for example 1,3-propylendiamine and 1,2-ethylendiamine. In such combinations, however, the majority of the alkylene groups bear 3 or 4 carbon atoms.

Preferably, aliphatic triamines or tetraamines are selected from N4-amine, N3-amine and combinations of N3-amine and N4-amine, for example in a molar ratio in the range of from 1:100 to 1:25.

Under amidation reaction conditions, preferably up to 5 mol-% of the secondary or tertiary hydroxyl groups may react, for example in tartaric acid or citric acid.

Core (a) may have an amino number in the range of from 400 to 1200 mg KOH/g, preferably 500 to 800 mg KOH/g.

As indicated above, at least 30 mol-% of the primary amino groups of core (a) are linked through an amide group or through a secondary amino group of the general formula —(CH₂)ₙ—NH—CH₂— to at least one mono-, di- or polysaccharide under formation of an amide group, preferably 40 to 80 mol-%, more preferably 70 to 100 mol-%.

In one embodiment of the present invention, said linkage may be accomplished by conversion of an alkyl ester or a lactone based on a mono-, di- or polysaccharide with said core (a).

Alkyl esters based on mono-, di- or polysaccharide, for example methyl esters or ethyl esters, based on a sugar acid are formed by esterification of a sugar ester with the respective alkanol.

Lactones based on mono-, di- or polysaccharide are formed by intramolecular esterification of a sugar acid, for example of gluconic acid, galacturonic acid, lactobionic acid (4-O-β-galactopyranosyl-D-gluconic acid), mannonic acid, galactonic acid, gluonic acid, and α-heptagluconic acid. The respective naturally occurring feedstock is preferred, thus, e.g., lactones based on D-gluconic acid, D-galacturonic acid, lactobionic acid, L-mannonic acid, D-galactonic acid, D-gluonic acid, and α-D-heptagluconic acid. Example of a lactone based on a polysaccharide is the condensation product of a monocarboxylic acid of maltodextrin. The monocarboxylic acid may be identified by ¹H and ¹³C NMR spectroscopy.

Specific examples of suitable lactones are glucuronolactone, D-galactono-γ-lactone, L-mannonic acid-γ-lactone, D-gulono-γ-lactone, D-gluconolactone, γ-gluconolactone, and α-D-heptagluconic acid-γ-lactone.

In one embodiment of the present invention, said lactone is selected from D-gluconolactone and lactobionolactone and the lactone based on monocarboxylic acid of maltodextrin.

In one embodiment of the present invention, polymers (A) have an amine value in the range of from 80 to 400 mg KOH/g, determined according to DIN EN ISO 9702 (1998), in other embodiments 10 to 100 mg KOH/g, preferably 20 to 70 mg KOH/g. The amine value refers to the sum of primary, secondary and tertiary amines.

In one embodiment of the present invention, polymer (A) has an average molecular weight Mw in the range of from 10,000 to 50,000 g/mol, determined by gel permeation chromatography (“GPC”) in hexafluoro isopropanol as mobile phase.

Inventive compositions may comprise impurities that stem from the synthesis of polymer (A), for example polyalkylene oxide of which at least 50 mol-% of the alkylene oxide groups are ethylene oxide groups.

In another embodiment of the present invention, core (a) is linked to at least one mono-, di- or polysaccharide comprises a secondary amino group of the general formula —(CH₂)ₙ—NH₂—CH₂— wherein the variable a is selected from 2 to 4. I-%. For example, the variable a may be 2 or 3 or 4.

In such embodiments, sugars eligible for formation of moiety (b) are reducing sugars. In the course of the conversion, a ring-opening reaction is observed.

Preferably, at least 50 mol-% of the —(CH₂)ₙ—NH₂ groups are converted.

Monosaccharides eligible as moiety (b) need to be based on aldose sugars, for example glyceraldehyde, erythrose, threose, ribose, arabinose, xylose and lyxose, and hexoses such as glucose, galactose, preferably in each case the D-enantiomer. Preferred monosaccharides are arabinose, xylose and glucose.

Examples of disaccharides eligible as moiety (b) are cellobiose, lactose, and maltose. Mixtures such as glucose syrup are suitable as well.

Examples of polysaccharides are maltodextrin and dextrin, maltodextrin being preferred. The dextrose equivalent may be used for calculating the amount of “aldehyde” groups that can be reacted with a —(CH₂)ₙ—NH₂ group of core (a).

The share of converted amino groups of core (a) is determined by measuring the secondary amine number, ASTM D2074. In one embodiment of the present invention, polymer (A) has an amine value, measured according to DIN 53240 (2013), in the range of from 10 to 2000, preferably 25 to 700 mg KOH/g polymer (A).

Details of the conversion reaction are disclosed further down below.

In one embodiment of the present invention, inventive compositions comprise at least one enzyme, in brief also enzyme (B).

Preferably, such enzyme (B) is selected from the list consisting of hydrolases, proteases, amylases, lipases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types, more preferably at least one enzyme being selected from proteases, is present-additionally for improvement of removal of oily/fatty stains, food stain removal and/or removal of complex stains

Any enzyme according to the invention relates to parent enzymes and/or variant enzymes, both having enzymatic activity. Enzymes having enzymatic activity are enzymatically active or exert enzymatic conversion, meaning that enzymes act on substrates and convert these into products. The term “enzyme” herein excludes inactive variants of an enzyme.

A “parent” sequence (of a parent protein or enzyme, also called “parent enzyme”) is the starting sequence for introduction of changes (e.g., by introducing one or more amino acid substitutions, insertions, deletions, or a combination thereof) to the sequence, resulting in “variants” of the parent sequences. The term parent enzyme (or parent sequence) includes wild-type enzymes (sequences) and synthetically generated sequences (enzymes) which are used as starting sequences for introduction of (further) changes.

The term “enzyme variant” or “sequence variant” or “variant enzyme” refers to an enzyme that differs from its parent enzyme in its amino acid sequence to a certain extent. If not indicated otherwise, variant enzyme “having enzymatic activity” means that this variant enzyme has the same type of enzymatic activity as the respective parent enzyme.

In one embodiment of the present invention, inventive compositions comprise
(B) at least one hydrolase, hereinafter also referred to as hydrolase (B), preferably selected from hydrolases, hereinafter also referred to as hydrolase (B).

In one embodiment, hydrolases (B) are selected from proteases, amylases, lipases, cellulases, and mannanases.

In one embodiment of the present invention, inventive compositions comprise
(B) at least one protease (B), hereinafter also referred to as protease (B).

In one embodiment of the present invention, inventive compositions comprise
(C) at least one anionic surfactant, hereinafter also being referred to as anionic surfactant (C).

Examples of anionic surfactants (C) are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples of anionic surfactants (C) are soaps, for example the sodium or potassium salts of stearic acid, oleic acid, palmitic acid, ether carboxylates, and alkylether phosphates.

In a preferred embodiment of the present invention, anionic surfactant (C) is selected from compounds according to general formula (I)

R¹—O(CH₂CH₂O)ₓ₂—SO₃M (I)
wherein
R¹ n-C₁₀-C₁₈-alkyl, especially with an even number of carbon atoms, for example n-decyl, n-dodecyl, n-tetradecyl, n-hexadecyl, or n-octadecyl, preferably C₁₀-C₁₄-alkyl, and even more preferably n-C₁₂-alkyl,
X2 being a number in the range of from 1 to 5, preferably 2 to 4 and even more preferably 3.
M being selected from alkali metals, preferably potassium and even more preferably sodium.

In anionic surfactant (C), x2 may be an average number and therefore n is not necessarily a whole number, while in individual molecules according to formula (III a), x denotes a whole number.

In one embodiment of the present invention, inventive compositions may contain 0.1 to 60% by weight of anionic surfactant (C), preferably 5 to 50% by weight.

Inventive compositions may comprise ingredients other than the aforementioned. Examples are non-ionic surfactants, fragrances, dyestuffs, biocides, preservatives, enzymes, hydrotropes, builders, viscosity modifiers, polymers, buffers, defoamers, and anti-corrosion additives.

Preferred inventive compositions may contain one or more non-ionic surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (II)

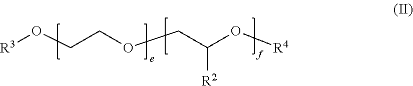

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III)

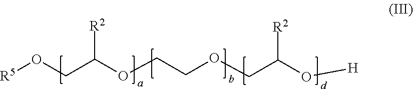

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Compounds of the general formula (III) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (IV) are likewise suitable.

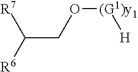

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y1 in the range of from 1.1 to 4, y1 being an average number,

Further examples of non-ionic surfactants are compounds of general formula (V) and (VI)

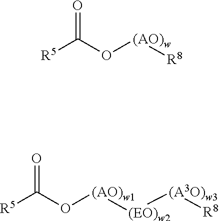

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A30 is selected from propylene oxide and butylene oxide,
W is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (VII)

R⁹R¹⁰R¹¹N→O (VII)
wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

In one embodiment of the present invention, inventive compositions may contain 0.1 to 60% by weight of at least one surfactant, selected from non-ionic surfactants, amphoteric surfactants and amine oxide surfactants.

In a preferred embodiment, inventive solid detergent compositions for cleaners and especially those for automatic dishwashing do not contain any anionic surfactant.

Inventive compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Examples of fragrances are benzyl salicylate, 2-(4-tert.-butylphenyl) 2-methylpropional, commercially available as Lilial®, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), benzoic acid, sorbic acid, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

Examples of biocides that are particularly of interest are the following antimicrobial agents and/or preservatives:
4,4′-dichloro 2-hydroxydiphenyl ether (CAS-No. 3380-30-1), further names: 5-chloro-2-(4-chlorophenoxy) phenol, Diclosan, DCPP, which is commercially available as a solution of 30 wt % of 4,4′-dichloro 2-hydroxydiphenyl ether in 1,2 propyleneglycol under the trade name Tinosan® HP 100;
and
2-Phenoxyethanol (CAS-no. 122-99-6, further names: Phenoxyethanol, methylphenylglycol, phenoxetol, ethylene glycol phenyl ether, ethylene glycol monophenyl ether, Protectol® PE);
2-bromo-2-nitropropane-1,3-diol (CAS-No. 52-51-7, further names: 2-bromo-2-nitro-1,3-propanediol, Bronopol®, Protectol® BN, Myacide AS);
Glutaraldehyde (CAS-No. 111-30-8, further names: 1-5-pentandial, pentane-1,5-dial, glutaral, glutardialdehyde, Protectol® GA, Protectol® GA 50, Myacide® GA);
Glyoxal (CAS No. 107-22-2; further names: ethandial, oxylaldehyde, 1,2-ethandial, Protectol® GL);
2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); mixtures of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3 (2H)-one (BIT, CAS No. 2634-33-5);
Hexa-2,4-dienoic acid (Sorbic acid, CAS No. 110-44-1) and its salts, e.g., calcium sorbate, sodium sorbate, Potassium (E,E)-hexa-2,4-dienoate (Potassium Sorbate, CAS No. 24634-61-5);
Lactic acid and its salts; especially sodium lactate,
L-(+)-lactic acid (CAS No. 79-33-4);
Benzoic acid (CAS No 65-85-0, CAS No. 532-32-1) and salts of benzoic acid, e.g., sodium benzoate, ammonium benzoate, calcium benzoate, magnesium benzoate, MEA-benzoate, potassium benzoate;
Salicylic acid and its salts, e.g., calcium salicylate, magnesium salicylate, MEA salicylate, sodium salicylate, potassium salicylate, TEA salicylate; Benzalkonium chloride, benzalkonium bromide, benzalkonium saccharinate (CAS Nos 8001-54-5, 63449-41-2, 91080-29-4, 68989-01-5, 68424-85-1, 68391-07-5, 61789-y71-7, 85409-22-9);
Didecyldimethylammonium chloride (DDAC, CAS No. 68424-95-3 and CAS No. 7173-51-5);
N-(3-aminopropyl)-N-dodecylpropane-1,3-diamine (Diamine, CAS No. 2372-82-9);
Peracetic acid (CAS No. 79-21-0);
Hydrogen peroxide (CAS No. 7722-84-1);
Biocide or preservative may be added to the inventive composition in a concentration of 0.001 to 10% relative to the total weight of the composition. Preferably, inventive compositions contain 2-phenoxyethanol in a concentration of 0.1 to 2% or 4,4′-dichloro 2-hydroxydiphenyl ether (DCPP) in a concentration of 0.005 to 0.6%.

The invention thus further pertains to a method of preserving an inventive composition against microbial contamination or growth, which method comprises addition of 2-phenoxyethanol.

The invention thus further pertains to a method of providing an antimicrobial effect on textiles after treatment with an inventive composition containing 4,4′-dichloro 2-hydroxydiphenyl ether (DCPP).

Examples of viscosity modifiers are agar-agar, carragene, tragacanth, gum arabic, alginates, pectins, hydroxyethyl cellulose, hydroxypropyl cellulose, starch, gelatin, locust bean gum, cross-linked poly(meth)acrylates, for example polyacrylic acid cross-linked with bis-(meth)acrylamide, furthermore silicic acid, clay such as—but not limited to—montmorillonite, zeolite, dextrin, and casein.

Hydrotropes in the context with the present invention are compounds that facilitate the dissolution of compounds that exhibit limited solubility in water. Examples of hydrotropes are organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid.

Inventive compositions may contain at least one polymer other than polymer (A).

Examples of polymers other than polymer (A) are especially polyacrylic acid and its respective alkali metal salts, especially its sodium salt. A suitable polymer is in particular polyacrylic acid, preferably with an average molecular weight M_{w} in the range from 2,000 to 40,000 g/mol. preferably 2,000 to 10,000 g/mol, in particular 3,000 to 8,000 g/mol, each partially or fully neutralized with alkali, especially with sodium. Suitable as well are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents. Further examples are copolymer of acrylic acid with comonomers bearing a sulfonic acid group, especially AMPS (2-acrylamido-2-methylpropane sulfonic acid) and its sodium salt.

Further examples of polymers other than polymer (A) are polyvinylpyrrolidones (PVP). Polyvinylpyrrolidones may serve as dye transfer inhibitors.

Polymers other than polymer (A) may include, without limitation, “multifunctional alkoxylated polyethylene imines” (for example BASF's Sokalan® HP20), “multifunctional alkoxylated diamines” (for example BASF's Sokalan® HP96) and also terephthalic acid-based polyesters like BASF's Sokalan® SR100 and Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight M_{w} in the range from 3000 to 250000, preferably 5000 to 200,000, more preferably 8000 to 100,000, even more preferably 8000 to 50000, even more preferably 10000 to 30000, and most preferably 10000 to 20000 g/mol. Suitable multifunctional ethoxylated polyethylene imines bear 80 wt.-% to 99 wt.-%, preferably 85 wt.-% to 99 wt.-%, more preferably 90 wt.-% to 98 wt.-%, most preferably 93 wt.-% to 97 wt.-% or 94 wt.-% to 96 wt.-% ethylene oxide side chains, based on the total weight of the respective polymer other than polymer (A). Ethoxylated polyethylene imines are typically based on a polyethylene imine core and a polyethylene oxide shell. Suitable polyethylene imine cores are polyethylene imines with a weight-average molecular weight M_{w} in the range of 500 to 5000 g/mol. Preferably employed is a molecular weight from 500 to 1000 g/mol, even more preferred is a M_{w} of 600 to 800 g/mol. The ethoxylated polyethylene imines then have on average 5 to 50, preferably 10 to 35 and even more preferably 20 to 35 ethylene oxide (EO) units per NH-functional group. Average molecular weights of alkoxylate d and especially ethoxylated polyethylene imines may be determined by gel permeation chromatography (GPC), for example with 0.1 M aqueous formic acid or with a 0.05% by weight potassium trifluoroacetate in hexafluoroisopropanol as mobile phase.

Suitable multifunctional alkoxylated diamines are typically ethoxylated C₂-C₁₂-alkylene diamines, preferably hexamethylene diamine, which are further quaternized and optionally sulfated. Typical multifunctional alkoxylated diamines have a weight-average molecular weight M_{w} in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contain on average 10 to 50, preferably 15 to 40 and even more preferably 20 to 30 ethylene oxide (EO) groups per NH-functional group, and which preferably bear two cationic ammonium groups and two anionic sulfate groups per molecule.

Further examples of polymers are polyethylene terephthalates, polyoxyethylene terephthalates, and polyethylene terephthalates that are end-capped with one or two hydrophilic groups per molecule, hydrophilic groups being selected from CH₂CH₂CH₂—SO₃Na, CH₂CH(CH₂—SO₃Na) 2, and CH₂CH(CH₂SO₂Na) CH₂—SO₃Na.

Examples of buffers are monoethanolamine and N, N, N-triethanolamine. Examples of defoamers are silicones.

Inventive compositions are not only good in cleaning soiled laundry with respect to clay soiling. Inventive liquid detergent compositions are very useful for removing bleachable stains such as, but not limited to stains from red wine, tea, coffee, vegetables, and various fruit juices like berry juices from laundry. They still do not leave residues on the clothes. In particular, inventive compositions work in cleaning laundry soiled with clay already at low temperatures, e.g., from 25 to 35 °C.

Examples of inventive formulations are summarized in Table A.

TABLE A
Liquid laundry frame formulations according to the invention

| | (numbers: % active) | | | | | |
|---|---|---|---|---|---|---|
| active | F1 | F2 | F3 | F4 | F5 | F6 |
| alcohol ethoxylate 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether | 5.40 | 8.80 | 7.10 | 7.10 | 5.40 | 14.00 |
| sulphate | | | | | | |
| Linear alkyl benzene | 5.50 | 0.00 | 14.50 | 15.50 | 10.70 | 0.00 |
| sulphonic acid | | | | | | |
| 1,2 Propane diol | 6.00 | 3.50 | 8.70 | 8.70 | 1.10 | 7.80 |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive polymer (A) | 0.1-5 | 0.1-5 | 0.1-5 | 0.1-5 | 0.1-5 | 0.1-5 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

A further aspect of the present invention is therefore the use of inventive compositions for laundry care. Laundry care in this context includes laundry cleaning.

A further aspect of the present invention is related to polymers (A), hereinafter also referred to as inventive polymers or inventive polymers (A). Inventive polymers (A) have been described in detail above.

Within another embodiment, polymers (A) exhibit at least 20%, preferably at least 40% or more preferably at least 60% biodegradability according to standard OECD 301F within 56 days, preferably within 28 days. More ideally, polymers (A) are readily biodegradable, i.e., show equal to or more than 60% oxygen consumption after 28 days in the OECD 301 F test or at least show equal to or more than 60% after 56 days in the OECD 301 F test. Alternatively, polymers (A) are inherently biodegradable in the OECD 302B test, i.e., show equal to or more than 70% dissolved organic carbon (DOC) levels.

Inventive polymers (A) are excellently suited for making inventive aqueous solutions. In addition, inventive polymers (A) may be formulated in pouches, for example in pouches made from a polymer film such as, but not limited to polyvinylalcohol. In such pouches, inventive polymer may be present as solution in diethylene glycol, triethylene glycol, in a polyethylene glycol that is liquid at ambient temperature, or 1,2-propylene glycol or the like that each may contain up to 15% by volume of water, preferably up to 10% by volume of water, referring to the sum of the respective glycol and water. For optical purposes, such inventive polymer in a pouch may be combined with a dyestuff.

In one aspect, the invention is directed to a method of improving the cleaning performance of a liquid detergent composition, by adding a polymer (A) according to the invention to a detergent composition preferably comprising at least one protease with our without at least one lipase.

The term “improved cleaning performance” herein may indicate that polymers (A) provide better, i.e., improved, properties in stain removal under relevant cleaning conditions, when compared to the cleaning performance of a detergent composition lacking polymer (A). In one embodiment, “improved cleaning performance” means that the cleaning performance of a detergent comprising polymer (A) and at least one enzyme, preferably at least one hydrolase (B), especially at least one protease (B), is improved when compared to the cleaning performance of a detergent comprising polymer (A) and no enzyme. In one embodiment, “improved cleaning performance” means that the cleaning performance of a detergent comprising polymer (A) and an enzyme, preferably hydrolase (B), more preferably protease (b), is improved when compared to the cleaning performance of a detergent comprising at least one enzyme, preferably at least one hydrolase (B), preferably protease (B) and no polymer (A).

The term “relevant cleaning conditions” herein refers to the conditions, particularly cleaning temperature, time, cleaning mechanics, suds concentration, type of detergent and water hardness, actually used in laundry machines, automatic dish washers or in manual cleaning processes.

Inventive polymers (A) are excellently suited as and particularly for the manufacture of inventive compositions. Inventive polymers (A) show good biodegradability according to OECD.

A further aspect of the present invention relates to a process for making inventive polymers (A), hereinafter also referred to as inventive process or inventive synthesis. The inventive process comprises step (α) and step (β) and step (γ), preferably either step (γ1) or step (γ2). Steps (α), (β) and (γ) are performed subsequently. Steps (α), (β) and (γ) are described in more detail below.

Steps (α) includes providing an aliphatic di-, tri- or tetracarboxylic acid or its respective C₁-C₂-alkyl ester, preferably an aliphatic C₄-C₈-di- or tricarboxylic acid or its respective C₁-C₂-alkyl ester. In C₁-C₂-alkyl esters, one or more carboxylic acid groups may be esterified with one or two different alcohols, preferably, all carboxylic acid groups are esterified with either methanol or ethanol.

Examples of carboxylic acids are adipic acid, glutamic acid, tartaric acid, malic acid, propane-1,2,3-tricarboxylic acid, citric acid, sebacic acid, succinic acid, butane 1,2,3,4-tetracarboxylic acid, and malonic acid, preferred examples are adipic acid, glutamic acid, tartaric acid, malic acid and citric acid.

Examples of respective C₁-C₂-alkyl esters are dimethyl adipate, diethyl adipate, triethyl citrate, dimethyl tartrate, diethyl tartrate, dimethyl glutamate, diethyl glutamate, malic acid dimethyl ester, glutamic acid diethyl ester, dimethyl sebacate, diethyl sebacate, and preferred C₁-C₂-alkyl esters are diethyl adipate, triethyl citrate, diethyl tartrate, dimethyl glutamate, and diethyl glutamate.

Aliphatic di-, tri- or tetracarboxylic acid or its respective C₁-C₂-alkyl ester as provided in step (α) may be provided in bulk or as solution, in bulk being preferred. Suitable solvents are alcohols and hydrocarbon, each with a boiling point of 100 °C or less at ambient pressure (1 bar abs.). Specific examples are methanol, ethanol, cyclohexane, and pentane.

Step (β) includes reacting said di-, tri- or tetracarboxylic acid or its respective C₁-C₂-alkyl ester with at least one aliphatic triamine or tetraamine, thereby forming a core (a).

The reaction of step (β) may be performed by mixing one aliphatic triamine or tetraamine with di-, tri- or tetracarboxylic acid or its respective C₁-C₂-alkyl ester and heating the resultant mixture.

In embodiments wherein free di-, tri- or tetracarboxylic acids are reacted in step (3), higher temperatures are applied than when esters are reacted, for example 160 to 200 °C, and water is removed by distillation. In order to avoid oxidation, in such embodiments step (B) is preferably performed under inert gas, for example nitrogen or argon, or under reduced pressure, for example 10 to 500 mbar.

In embodiments wherein C₁-C₂-alkyl esters of di-, tri- or tetracarboxylic acids are reacted, a temperature in the range of from 50 to 80 °C, preferably 55 to 75 °C. C₁-C₂-alkyl alcohol formed during the reaction may be distilled off, at ambient pressure or preferably under reduced pressure, for example 15 to 500 mbar or starting at ambient pressure and then reducing the pressure.

An advantage of reacting C₁-C₂-alkyl ester of di-, tri- or tetracarboxylic acids is that milder reaction conditions, especially with respect to the temperature, may be applied, and cores (a) with a lower Hazen colour number may be obtained.

The duration of step (β) may be in the range of from 30 minutes to 20 hours, preferably 1 to 10 hours. The reaction is preferably terminated as soon as no more C₁-C₂-alkyl alcohol or water, as the case may be, is distilling off.

Step (β) may be performed with or without a catalyst, without being preferred.

In one embodiment of the present invention, core (a) has an amine value in the range of from 400 to 1200 mg KOH/g, determined according to DIN EN ISO 9702 (1998), preferably 500 to 800 mg KOH/g. The amine value refers to the sum of primary, secondary and tertiary amines.

Step (γ) includes linking core (a) to a mono-, di- or polysaccharide by either
(γ1) reacting said core (a) with at least one lactone based on a mono-, di- or polysaccharide under formation of an amide group or
(γ2) reacting said core (a) with at least one sugar molecule based on a mono-, di- or polysaccharide in the presence of hydrogen and a catalyst or in the presence of an aminoborane.

In one embodiment of the present invention, step (γ1) includes reacting said core (a) with at least one lactone based on a mono-, di- or polysaccharide under formation of an amide group.

Step (γ1) may be carried out at temperatures in the range of from ambient temperature to 120 °C. Preferred are 25 to 70 °C. In case of solvents like methanol and ethanol, the boiling temperature is the upper limit. Even more preferred are 40 to 65 °C.

Step (γ1) may be carried out at a pressure in the range of from 1 to 10 bar (absolute), preferably at ambient pressure.

The reaction time of step (γ1) may be in the range of from 0.5 to 12 hours.

In another embodiment, step (γ) is performed under reduction condition, hereinafter also referred to as step (γ2). In such embodiments, step (γ2) includes a reduction of the sugar molecule and a coupling with core (a).

Step (γ2) may be carried out at temperatures in the range of from ambient temperature to 120 °C. Preferred are 25 to 70 °C. In case of solvents like methanol and ethanol, the boiling temperature is the upper limit. Even more preferred are 40 to 65 °C.

In one embodiment of the present invention, especially when hydrogen in the presence of a catalyst is used, step (γ2) is carried out at a pressure in the range of from 1 to 200 bar (absolute). In another embodiment of the present invention, especially when an aminoborane is used as a reducing agent, step (γ2) is carried out at a pressure in the range of from 1 to 5 bar (absolute), especially at ambient pressure.

In one embodiment of the present invention, especially when hydrogen in the presence of a catalyst is used, step (γ2) is carried out at a temperature in the range of from 25 to 125 °C. In another embodiment of the present invention, especially when an aminoborane is used as a reducing agent, step (γ2) is carried out at a temperature in the range of from 20 to 100 °C.

Examples of suitable catalysts are hydrogenation catalysts such as, but not limited to Raney metals such as Raney-nickel as well as supported metal catalysts such as Ru, Rh or Pd on charcoal, silica or ZrO₂.

Examples of suitable aminoboranes are in particular aromatic aminoboranes, for example aniline-BH₃, picoline boranes such as α-picoline borane, pyridine borane, pyridine tetrahydroborato zinc and also other boron-based reducing agents, such as sodium cyanoborohydride, sodium triacetoxyborohydride, sodium borohydride, and titanium isopropoxide/sodium borohydride.

Each hydrogen and aminoborane are used in at least stoichiometric an amount, preferably in excess with respect to reducable “aldehyde” group of the sugar molecule.

Step (γ2) is preferably carried out at a slightly acidic pH value, for example 3 to 6.5, preferably 3.5 to 5.5. The pH value may be adjusted by addition of a carboxylic acid such as, but not limited to formic acid or acetic acid.

Without wishing to be bound by any theory, we assume that in a first reaction, an amino group reacts with the “aldehyde” group under ring opening and formation of a hemi-aminal, followed by reduction of the hemi-aminal to a secondary amino group.

In one embodiment of the present invention, the reaction time of step (γ2) is generally in the range of from one to 36 hours.

When methanol is used as a solvent, inventive polymer (A) precipitates.

After performance of step (γ), work-up steps may be performed such as, but not limited to precipitation of polymer (A), removal of any solvent used, e.g., by distilling it off. The precipitation of polymer (A) may be achieved by the addition of a “non-solvent”, e.g., methanol.

Methanol is a very preferred solvent for carrying out step (γ) because many core molecules (a) and lactones (b) are soluble in methanol but many resultant polymers (A) are not, and unreacted starting materials and methanol may then at least partially be removed by decantation or filtration.

In one embodiment of the present invention, after step (γ) has ended, bleaching can be carried out, for example with peroxide such as H₂O₂.

By the inventive process, inventive polymers (A) are obtained in good yield and sufficient purity.

For work-up, any solvent used if applicable is removed, e.g., by evaporation, for example under reduced pressure. If no solvent is used polymer (A) may be used without further work-up.

The invention is further illustrated by working examples.

### General Remarks:

Reactions were carried out under nitrogen atmosphere unless expressly noted otherwise.
Percentages refer to % by weight unless expressly stated otherwise.
GPC was carried out with THE as mobile phase, with linear PMMA as internal standard and polystyrene-1,3-divinylbenzene gel as stationary phase
Hydroxyl values (OH values) were determined according to DIN 53240 (2013).
Amine values were determined according to DIN EN ISO 9702 (1998). rpm: revolutions per minute. NI: norm liter, volume determined at ambient pressure and 23 °C.

The amount and type of amines substituted with residues, such as, for example, cores (a) and polymers (A) and, optionally, the presence of hydrogen can be determined by identification of primary, secondary and tertiary amino groups in ¹³C-NMR, as described for polyethylenimines in Lukovkin G. M. et al.: Europ. Polymer Journal 1973, 9, 559-565 and St. Pierre T. et al., Geckle M.: ACS Polym. Prep. 1981, 22, 128-129.

¹³C-NMR spectra were recorded in CDCl₃ with a Bruker AV-401 instrument at ambient temperature. ¹H-NMR spectra were recorded in CDCl₃ or CD₃OD with a Bruker AV-401 instrument at ambient temperature.

### I. Synthesis of Inventive Polymers (A)

### I.1 Starting Materials

### I.1.1 Listing of Certain Starting Materials

The following commercially available starting materials were provided:
(a. 1) triethylcitrate
(a.2) diethyl L-(+)-tartrate

N,N′-bis(3-aminopropyl)ethylenediamine (N4-amine), contains up to 4 mol-% N,N-bis(3-aminopropyl)ethylenediamine and up to 3 mol-% N3-amine N,N′-bis(3-aminopropyl)-1,3-propylenediamine
(b.1): gluconolactone
(b.3): maltodextrin, DE 19, purchased from Cargill® Cpur Series
(b.4): maltose
   I.1.2 Synthesis of maltodextrin lactone, (b.2)

A 4-liter glass reactor was charged with 1800 g deionized water, 991.3 g maltodextrin-DE-19 (b.3), (with a dextrose equivalent of 19) and 24.6 g NaBr. Under constant stirring (100 rpm), 789 g aqueous solution of sodium hypochlorite (active content=11.1%) was added during 60 min. The pH value of the resulting reaction mixture was kept constant at 8.0 by adding simultaneously 430.3 g aqueous solution of sodium hydroxide (8% NaOH). During addition of the sodium hypochlorite, the temperature was kept between 22 °C and 31 °C.

After completion of addition of the sodium hypochlorite and the sodium hydroxide the resultant reaction mixture is stirred for 24 hours at 22 °C. Water was partially removed from the reaction mixture by distillation under vacuum at 60 °C until a sirup-like liquor was obtained, hereinafter also referred to as (b.2).

A small quantity of the reaction mixture was dried 24 hours in vacuum at 60 °C.

### Analytics:

¹H-NMR in D₂O: By the ratio of the signals at o=5.18 ppm and 0=5.24 ppm a degree of oxidation of appr. 80% was calculated.

13C-NMR in D20: A new signal at o=178 ppm (assigned to the carboxylate-C) was detected which was not present in the maltodextrin starting material.

Mw of polymers (A) was determined by GPC, hexafluoroisopropanol (HFIP) as mobile phase

### I.2 Syntheses of Cores (a)

### I.2.1 Synthesis of Core (a.1), Step (β0.1)

A one-liter four-neck flask equipped with stirrer and distillation head was charged with 522.9 g (3 mol) of N4-amine. An amount of 276.3 g (1 mol) (a.1) was added over the period of four hours. The resulting mixture was heated to 60 °C at ambient pressure for four hours. Then, the pressure was reduced and ethanol formed was distilled off. Then, the reaction mixture was cooled to ambient temperature. Core (a. 1) was obtained as yellow viscous substance. IR and ¹H NMR showed almost complete conversion to the amide.

### I.2.2 Synthesis of Core (a.2), Step (β0.2)

A one-liter four-neck flask equipped with stirrer and distillation head was charged with 200 g (1.06 mol) of N,N′-bis(3-aminopropyl)-1,3-propylenediamine. An amount of 97.8 g (0.35 mol) (a. 1) was added over the period of four hours. The resulting mixture was heated to 60 °C at ambient pressure for four hours. Then, the pressure was reduced and ethanol formed was distilled off. Then, the reaction mixture was cooled to ambient temperature. Core (a.2) was obtained as yellow viscous substance. IR and ¹H NMR showed almost complete conversion to the amide.

### I.2.3 Synthesis of Core (a.3), Step (β0.3)

A two-liter four-neck flask equipped with stirrer and distillation head was charged with 522.9 g (3 mol) of N4-amine. An amount of 412.4 (2 mol eq.) (α.2) was added over the period of four hours. The resulting mixture was heated to 60 °C at ambient pressure for four hours. Then, the pressure was reduced and methanol as well as ethanol formed was distilled off. Water was added during the distillation. Then, the reaction mixture was cooled to ambient temperature. Core (a.3) was obtained as yellow viscous solution (40% by weight). IR and 1H NMR showed almost complete conversion to the amide.

### I.2.4 Synthesis of Core (a.4), Step (B.4)

A two-liter four-neck flask equipped with stirrer and distillation head was charged with 435.8 g (5 mol-eq.) of N4-amine. An amount of 276.3 g (1 mol, 2 mol-eq) (a.1) was added over the period of four hours. The resulting mixture was heated to 60 °C at ambient pressure for four hours. Then, the pressure was reduced and the ethanol formed was distilled off. Then, the reaction mixture was cooled to ambient temperature. Core (a.4) was obtained as a dark yellow viscous substance. IR and ¹H NMR showed almost complete conversion to the amide.

### I.3 Syntheses of Inventive Polymers

### I.3.1 Synthesis of Inventive Polymer (A.1), Step (γ1.1)

A 500 ml four-neck-round-bottom flask was charged with 50 g of core (a.1). Then, 250 g methanol were added, followed by 40.5 g glucono-lactone (b.1). The resultant reaction mixture was heated under stirring to 60 °C for 2 hours. The methanol was then removed by distillation under reduced pressure and the residue was dried in vacuum of 50 to 100 mbar at 40 °C for 24 h. Yield of polymer (A.1): 65 g of a solid. ¹H-NMR in D₂O showed conversion at least 90 mol-% of the glucono-lactone by reaction with the primary amino groups of core (a.1). M_{w} of (A.1): 16,600 g/mol

### I.3.2 Synthesis of Inventive Polymer (A.2), Step (γ1.2)

A 500 ml four-neck-round-bottom flask was charged with 98.3 g of lactone (b.2), actives: 87.6%. Then, 240 g DMSO (dried over molecular sieve) were added, followed by 20 g of core (a.1). The resultant reaction mixture was heated under stirring to 60 °C for 2 hours. Then, the resultant mixture was poured into a beaker containing 750 g dry methanol for precipitation of polymer (A.2). The precipitated polymer (A.2) was separated from the DMSO and the methanol by filtration and washed 3 times with 200 g dry methanol and then dried in vacuo of 50 to 100 mbar at 40 °C for 48 h. Yield: 76 g solid. ¹H-NMR in D₂O showed a conversion of at least the malto-lactone by reaction with the primary amino groups of core (a.1). M_{w} of (A.2): 30,100 g/mol

### I.3.3 Synthesis of Inventive Polymer (A.3), Step (γ2)—General Protocol

In a magnetically coupled stirred 300-mL-autoclave (stainless steel V4A) with inclined blade stirrer, electric heating, internal temperature cascade control; H₂ press-on via iterative differential pressure dosing, 45 g of the respective sugar (b) were dissolved in water to obtain 100 ml of a 50 wt. % solution. The resulting solution was mixed with the corresponding core (a) to obtain a DE/amine molar ratio according to Table 1. An amount of 15 g catalyst —Ru/ZrO₂— was added. The autoclave was flushed with nitrogen and then with hydrogen. Then, 10 bar hydrogen were pressed on cold. The reactor heated to 60 °C under hydrogen pressure of 50 bar for 12 hours and stirred at 500 rpm. Then, the autoclave was allowed to cool to ambient temperature, expanded and degassed. The resulting reaction mixture was purified by a freeze drying procedure. Lyophilization conditions: Freeze-drying at approx. 75 °C at a refrigeration machine and −70 °C in the condenser (in the chamber). Freeze-dryer Sublimator EKS 100. The sample was rapidly cooled in the first chamber, to about −50 °C. The compressor then created a “vacuum” in the second chamber with a maximum pressure of 6.10 mbar. This strongly negative pressure causes the moisture to pass the valve from the product chamber into the second chamber. Then the resultant polymer was washed with 50 ml methanol prior to drying.

### Specific Examples in Tabular Form

TABLE 2
Manufacture of inventive polymers

| polymer | core (a) | core [g] | Mol (b)/NH₂-groups | (b) | Mw [g/mol] |
|---|---|---|---|---|---|
| (A.3) | (a.1) | 20 | 9.0 | (b.4) | 12,500 |
| (A.4) | (a.1) | 18 | 6.0 | (b.4) | 11,200 |

Mol (b)/NH₂-groups characterizes the molar ratio of sugar (b) to core (a)

### II. Manufacture of Inventive Laundry Detergent Compositions and Laundering Tests

### II.1 Primary Cleaning Performance

The primary wash performance of inventive polymers was tested in Launder-O-Meter (from SDL Atlas, Rock Hill, USA) by preparing wash solutions using water of 7°dH hardness (1.2 mmol/L; Ca:Mg:HCO₃ 4:1:8) containing 3.0 g/L of the liquid test detergent L. 1, see composition in Table 3, and 3.0% of an inventive polymer (A).

TABLE 3
Ingredients of base mixture L.1 for a liquid detergent formulation

| ingredient | % by weight |
|---|---|
| Linear alkylbenzene sulfonic acid (C₁₂-C₁₄), Na salt | 5.5 |
| lauryl ether 2 EO sulphate (C.1) | 5.4 |
| C₁₂/C₁₅-fatty alcohol reacted with 7 moles of EO | 5.4 |
| Coconut C₁₂-C₁₈-alkyl fatty acid | 2.4 |
| Sodium hydroxide | 2.2 |
| 1,2 propylene glycol | 6.0 |
| ethanol | 2.0 |
| Sodium citrate | 3.0 |
| Polymer (A) | 3.0 |
| Water | to 100 |

To determine the primary detergency, the cleaning performance on 4 different particulate stains on a polyester fabric (CFT, Vlaardingen, The Netherlands) was measured by determining the color difference (delta E) between the stains after wash and the unsoiled white fabric using a reflectometer (Mach5 plus, a multi area color measurement instrument available from ColourConsult, Beverwijk, The Netherlands). Each experiment containing the 4 different circular particulate stains (Clay ground soil, Standard clay, Red pottery clay, Tennis court clay; All 4 stains on one polyester fabric, 2 of those fabrics per wash) was repeated 4 times, and the obtained data was used to calculate the average delta E value.

By using these delta E values, the so-called “standardized cleaning performance” (delta delta E) has been calculated for each individual stain. The “standardized cleaning performance” (delta delta E) is the difference of the performance of the laundry detergent including the inventive polymer vs. the laundry detergent w/o any inventive polymer.

Table 4 shows the washing test conditions and Table 3 summarizes the obtained standardized cleaning performance. The standardized cleaning performance shown in Table 3 is the sum of the standardized cleaning performance of all 4 stains. The bigger the sum of the delta delta E value, the bigger the positive contribution of the inventive polymer vs. the laundry detergent w/o any inventive polymer on the cleaning performance.

TABLE 4
Washing conditions for evaluation of primary
cleaning performance on particulate stains

| Washing conditions | | |
|---|---|---|
| Device | Launder-O-Meter from SDL Atlas, Rock Hill, USA | |
| Washing liquor | 250 | mL |
| Washing time | 30 | minutes |
| Washing | 30 | °C |
| temperature | | |
| Detergent | 3.0 | g/L |
| concentration | | |

| | |
|---|---|
| Water hardness | 1.2 mmol/L (4:1:8) (7° dH) |
| (Ca:Mg:HCO₃) | |
| Fabric to | 1:10 |
| liquor ratio | |
| Inventive | 3% by weight (vs. liquid laundry detergent) of |
| polymer (A) | the polymer, 100% active ingredient |
| Test fabric * | 4 different circular particulate stains (P-H018, |
| | P-H115, P-H144, P-H145) (CFT, Vlaardingen, |
| | The Netherlands) on one polyester fabric; 2 |
| | stained fabrics per wash |
| Ballast fabric | 2.5 g SBL 2004 (Soil Ballast Fabric ‘Formula |
| | 2004’ that simulates sebum grease stains; WFK |
| | Testgewebe GmbH, Brueggen, Germany); + |
| | additional white cotton ballast |

* After the washing experiment, the test fabrics were rinsed with tap water followed by drying at ambient room temperature overnight, prior to the measurement with the Mach5 plus.

TABLE 5
Results from washing tests (primary cleaning
performance on particulate stains).

| | | | Standardized cleaning |
|---|---|---|---|
| | | Concentration of | performance (sum |
| Detergent | Polymer | polymeric additive * | delta delta E) |
| L.1 | (A.1) | 3 wt % | 6.5 |
| L.1 | (A.2) | 3 wt % | 4.6 |

* All data are wt % active ingredient, independent of the respective product form.

### Test Results:

The experimental error is +/−2 delta delta E units. Therefore, any value>2 (sum delta delta E) means that the respective polymer provides a measurable and/or visible contribution to the overall cleaning performance of the respective detergent formulation; any value>4 (sum delta delta E) means that the respective polymer provides a significant contribution to the overall cleaning performance, i.e., the respective polymer leads to a significant improvement of the formulation. It can be concluded from Table 3 that all inventive polymers (A) tested exhibit significant cleaning benefits on particulate stains.

### II.2 Secondary Detergency/Antigreying Performance

To determine the secondary detergency, the whiteness of 8 different test fabrics was measured by determining the color difference (delta E) between the test fabrics after wash and the unsoiled (white) test fabric before wash, using a reflectometer (Mach5 plus, a multi area color measurement instrument available from ColourConsult, Beverwijk, The Netherlands). By using these delta E values, the so-called “standardized cleaning performance” (delta delta E) has been calculated for each individual fabric. The “standardized cleaning performance” (delta delta E) is the difference of the performance of the laundry detergent including the respective inventive polymer vs. the laundry detergent w/o any inventive polymer, respectively.

Table 3 shows the composition of the laundry detergent, Table 6 shows the washing test conditions and Table 5 summarizes the obtained standardized secondary cleaning performance. The standardized cleaning performance shown in Table 5 is the sum of the standardized cleaning performance of all 8 test fabrics. The bigger the sum of the delta delta E value, the whiter the fabrics after wash and therefore the bigger the positive contribution (anti-redeposition benefit) of the respective inventive polymer on the secondary cleaning performance.

The secondary detergency performance of inventive polymers was tested in Launder-O-Meter (from SDL Atlas, Rock Hill, USA) by preparing wash solutions using water of 14°dH hardness (2.5 mmol/L; Ca:Mg:HCO₃ 4:1:8) containing 3.0 g/L of the liquid test detergent L. 1, see composition in Table 1, and 3.0% of an inventive polymer (A).

TABLE 6
Washing conditions for evaluation of secondary
detergency of inventive polymers

| Washing conditions | | |
|---|---|---|
| Device | Launder-O-Meter from SDL Atlas, Rock Hill, USA | |
| Washing liquor | 250 | mL |
| Washing time | 30 | minutes |
| Washing | 30 | °C |
| temperature | | |
| Detergent | 3.0 | g/L |
| concentration | | |

| | |
|---|---|
| Water hardness | 2.5 mmol/L (4:1:8) (14° dH) |
| (Ca:Mg:HCO₃) | |
| Washing cycles* | 2 |
| Fabric to | ~1:10 |
| liquor ratio | |
| Inventive | 3% by weight (vs. liquid laundry detergent) of |
| polymer (A) | the polymer, 100% active ingredient |
| Test fabric** | 8 different test fabrics: 1.0 g WFK 10A |
| | (standard cotton), 2.0 g WFK 12A (cotton terry |
| | cloth), 0.9 g WFK 80A (cotton knit) (fabrics from |
| | WFK Testgewebe GmbH, Brueggen, |
| | Germany), 1.1 g EMPA 221 (cotton fabric, |
| | cretonne, bleached, without optical brightener; |
| | EMPA Testmaterials, St. Gallen, Switzerland), |
| | 1.0 g T-shirt according to EN/EC 60456, 1.0 g |
| | WFK20A (polyester 65%, cotton 35%), 1.0 g |
| | WFK30A (polyester), 0.8 g EMPA 406 |
| | (polyamide 6.6 spun, type 200, plain weave, |
| | ISO 105-F03) |
| Soil fabric*** | 3 pieces of a circular red pottery clay stain on |
| | knitted cotton (diameter: 2 cm; weight: each ca. |
| | 3.2 g; CFT, Vlaardingen, The Netherlands); + |
| | 2.5 g SBL 2004 (Soil Ballast Fabric ‘Formula |
| | 2004’ that simulates sebum grease stains; WFK |
| | Testgewebe GmbH, Brueggen, Germany) |

*After each cycle, the test fabrics were rinsed with 14° dH water (2 times), followed by drying at ambient room temperature overnight.
**After the end of the washing experiment, the test fabrics were rinsed with 14° dH water (2 times), followed by drying at ambient room temperature overnight, prior to the measurement with the reflectometer.
***New soiled fabric was used for each cycle

TABLE 7
Results from washing tests (secondary detergency).

| | | | Standardized cleaning |
|---|---|---|---|
| | | Concentration of | performance (sum |
| Detergent | Polymer | polymeric additive * | delta delta E) |
| L.1 | (A.1) | 3 wt % | n.a. |
| L.1 | (A.2) | 3 wt % | n.a. |
| L.1 | (A.3) | 3 wt % | 25.5 |
| L.1 | (A.4) | 3 wt % | 28.9 |

* All data are wt % active ingredient, independent of the respective product form.
n.a.: not available

The standardized cleaning performance shown in Table 5 is the sum of the standardized cleaning performance of all 8 test fabrics. The bigger the sum of the delta delta E value, the whiter the fabrics after wash and therefore the bigger the positive contribution (anti-redeposition benefit) of the respective inventive polymer on the secondary cleaning performance.

### III. Biodegradation Tests

General: the tests were carried out in accordance with the OECD Guidelines. According to the OECD guidelines a test is valid if:
1. The reference reaches 60% within 14 days.
2. The difference of the extremes of the test replicates by the end of the test is less than 20%.
3. Oxygen uptake of inoculum blank is 20 to 30 mg O₂/l and must not be greater than 60 mg O₂/l.
4. The pH value measured at the end of the test must be between 6 and 8.5.

Description of the test method used in the context of the present invention: Biodegradation in sewage was tested in triplicate using the OECD 301F manometric respirometry method. OECD 301F is an aerobic test that measures biodegradation of a sewage sample by measuring the consumption of oxygen. To a measured volume of sewage, 100 mg/L test substance, which is the nominal sole source of carbon, was added along with the inoculum (aerated sludge taken from the municipal sewage treatment plant, Mannheim, Germany). This sludge was stirred in a closed flask at a constant temperature (25 °C) for 28 days. The consumption of oxygen is determined by measuring the change in pressure in the closed flask using an Oxi TopC. Carbon dioxide evolved was absorbed in a solution of sodium hydroxide. Nitrification inhibitors were added to the flask to prevent consumption of oxygen due to nitrification. The amount of oxygen taken up by the microbial population during biodegradation of the test substance (corrected for uptake by a blank inoculum run in parallel) is expressed as a percentage of ThOD (theoretical oxygen demand, which is measured by the elemental analysis of the compound). A positive control glucose/glutamic acid is run along with the test samples for each cabinet as reference. Calculations: Theoretical oxygen demand: Amount of O₂ required to oxidize a compound to its final oxidation products. This amount is calculated using the elemental analysis data. % Biodegradation

Experimental O₂ uptake×100 and divided by the theoretical oxygen demand. The results of biodegradability tests are summarized in Table 8.

TABLE 8
summary of biodegradation tests

| sample | Biodegradation [%] |
|---|---|
| (A.2) | 53 |
| (A.3) | 40 |

In each test, the reference had a biodegradability of more than 60%.

1. An aqueous composition comprising
(A) at least one polymer comprising
(a) a core formed by an aliphatic di-, tri- or tetracarboxylic acid amidated with aliphatic triamine or tetraamine, wherein the amino groups of said tri- or tetramine are connected through C₂-C₄-alkylene groups, wherein at least 50 mol-% of the C₂-C₄-alkylene groups are alkylene groups with at least three carbon atoms, and
(b) wherein at least 30 mol-% of the primary amino groups of core (α) are linked through an amide group or through a secondary amino group of the general formula —(CH₂)ₙ—NH—CH₂—to at least one mono-, di- or polysaccharide, the variable a being selected from 2 to 4.

2. The composition according to claim 1, wherein said aqueous composition is a laundry detergent.

3. The composition according to claim 1, wherein said aliphatic di-, tri- or tetracarboxylic acid is selected from the group consisting of adipic acid, glutamic acid, tartaric acid, malic acid and citric acid.

4. The composition according to claim 1, wherein said mono- or polysaccharide is selected from the group consisting of gluconolactone and lactobionolactone and the condensation product of a monocarboxylic acid of maltodextrin.

5. The composition according to claim 1, wherein the at least one polymer (A) has an amine value in a range of from 80 to 400 mg KOH/g, determined according to DIN EN ISO 9702.

6. The composition according to claim 1, wherein said composition further comprises
(B) at least one hydrolase.

7. The composition according to claim 1, wherein said composition further comprises (C) at least one anionic surfactant.

8. The composition according to claim 1, wherein said aliphatic triamines or tetraamines are selected from the group consisting of N,N′-bis(3-aminopropyl)-1,3-propanediamine, N,N′-bis(3-aminopropyl)-1,2-ethylenediamine (N4-amine), 2-aminoethyl-1,3-propanediamine (N3-amine) and combinations of 2-aminoethyl-1,3-propanediamine (N3-amine), and N,N′-bis(3-aminopropyl)-1,2-ethylenediamine (N4-amine).

9. The composition according to claim 1, wherein said composition further comprises
(B) at least one enzyme, and
(C) at least one anionic surfactant.

10. A method of using the composition according to claim 1, the method comprising using the composition for laundry care.

11. A polymer (A) comprising
(a) a core formed by an aliphatic di-, tri- or tetracarboxylic acid amidated with aliphatic triamine or tetraamine wherein the amino groups are connected through C₂-C₄-alkylene groups, wherein at least 50 mol-% of the C₂-C₄-alkylene groups are alkylene groups with at least three carbon atoms, and
(b) wherein at least 30 mol-% of the primary amino groups of the tri- or tetramine are linked through an amide group or through a secondary amino group of the general formula —(CH₂)ₙ—NH—CH₂—to at least one mono-, di- or polysaccharide, the variable a being selected from 2 to 4.

12. The polymer according to claim 11, having an amine value in a range of from 80 to 400 mg KOH/g, determined according to DIN EN ISO 9702.

13. The polymer according to claim 11, wherein said aliphatic di-, tri- or tetracarboxylic acid is selected from the group consisting of adipic acid, glutamic acid, tartaric acid, malic acid and citric acid.

14. The polymer according to any of claim 11, wherein said aliphatic triamines or tetraamines are selected from the group consisting of N,N′-bis(3-aminopropyl)-1,3-propanediamine, N,N′-bis(3-aminopropyl)-1,2-ethylenediamine (N4-amine), 2-aminoethyl-1,3-propanediamine (N3-amine) and combinations of 2-aminoethyl-1,3-propanediamine (N3-amine) and N,N′-bis(3-aminopropyl)-1,2-ethylenediamine (N4-amine).

15. Process A process for making polymers according to claim 11 comprising the steps of
(α) providing an aliphatic di-, tri- or tetracarboxylic acid or its respective C₁-C₂-alkyl ester,
(β) reacting said di-, tri- or tetracarboxylic acid or its respective C₁-C₂-alkyl ester with at least one aliphatic triamine or tetraamine, thereby forming a core (a), and
(γ) linking core (a) to a mono-, di- or polysaccharide by either,
(γ1) reacting said core (a) with at least one lactone based on a mono-, di- or polysaccharide under formation of an amide group, or
(γ2) reacting said core (a) with at least one sugar molecule based on a mono-, di- or polysaccharide in the presence of hydrogen and a catalyst or in the presence of an aminoborane.
